(19) United States
(12) Patent Application Publication
(10) Pub. No.: US 2006/0142081 A1
(43) Pub. Date: Jun. 29, 2006

(54) Method for using a game pad as a realistic lower body game controller

(76) Inventor: Timothy David Kil, San Diego, CA (US)

Correspondence Address: Timothy Kil, 4879 Clairemont Mesa Blvd, #802, San Diego, CA, 92117, US

(21) Appl. No.: 10/906,460

(22) Filed: Feb. 22, 2005

Related U.S. Application Data
(60) Provisional application No. 60/593,243, filed on Dec. 27, 2004.

(51) Int. Cl. A63F 13/00

(52) U.S. Cl. 463/36

(57) ABSTRACT

The present invention includes a method for controlling a character in a video game in which the controller is a game pad that has foot-activated buttons upon it and in which the player can use realistic lower body movements to move the character. As the player performs realistic movements upon the game pad, a container of inputs is populated, the container is analyzed and appropriate commands are started which propel the character in the video game. Periodically, the statuses of the buttons on the game pad are analyzed and, if appropriate, commands are started. Also periodically, commands are checked to see if they have expired and, if needed, they are stopped.

### BACKGROUND OF THE INVENTION

1. Field of the Invention

The invention relates generally to electronic entertainment systems, and more particularly to a method for controlling games using realistic lower body movements on a game pad.

2. Description of the Related Art

Video games have historically been controlled using only the players' hands. Alternative methods of playing games are becoming increasingly popular. For example, the DDR (Dance Dance Revolution) type of game has become popular worldwide. DDR has a game pad that the player stands on with buttons that are pressed by the player's feet. The object of the game is to press the buttons at the correct time as indicated by the visual display. DDR differs from the present invention in that the present invention allows for a player to control characters that are moving about their environments, for example in a first-person shooter game, as opposed to dancing in one spot.

Other increasingly popular alternative types of games are the full body games such as Sony Corporation's EyeToy that use real-time movement tracking cameras. Movement of the players' arms or upper body is detected by the cameras in order to control the action of the game. Another example of these games are the Xavix products from SSD Company Limited. These involve an object like a tennis racket, baseball bat, or bowling ball that is detected by their motion detection system. The EyeToy and Xavix products are different from the present invention in that the present invention is for using lower body movements to control a character where the detector of player movement is a game pad that has a multitude of buttons upon it which are foot-activated.

A fourth type of game are those such as Virtual Fighting Arena and Naki International's Ultimate Kick Boxing Arena. These involve using a game pad similar to that used in DDR but with motion detecting sensors attached to the players' arms and legs also. The present invention differs from these in that the present invention is for games that are not one on one fighting games. The present invention concerns a player controlling a character that is moving through its environment, not standing in one place and/or only controlling its location in a very limited manner. The current invention's primary movements are not fighting movements, but movements to propel the character from one location to another. Stepping on a button labeled “left” to turn a character left is not an achievement of the present invention, but having the player step on a upper right button then the middle left button as if the player where really turning would be what the present invention achieves.

### SUMMARY OF THE INVENTION

It is the objective of the present invention to present a method in which realistic lower body movements can be used to control a game via a game pad upon which the player stands and has a multitude of foot-activated buttons.

The realistic body movements are a possibility due to the invention's process of storing a sequence of inputs, analyzing them, calling the appropriate command, and then stopping the command at the appropriate time.

This invention could be used to control any type of game that involves a character moving through its environment by use of their lower body to propel them. For example, using realistic body movements a player can command its character to move forward, turn left, turn right, move backwards, move upwards, move downwards, sidestep/strafe right, sidestep/strafe left, and crouch.

### BRIEF DESCRIPTION OF THE DRAWINGS

Features and advantages of the present invention will become apparent to those skilled in the art from the following descriptions with reference to the drawings, in which:

FIG. 1 is a diagram showing an example of a game pad commonly called a dance pad;

FIG. 2 is a overall flowchart describing how new input from the game pad is processed;

FIG. 3 is a flowchart describing how a new button press is added to the button press container;

FIG. 4 is a flowchart describing the process of checking new input and starting new commands;

FIG. 5 is a overall flowchart describing the process of a new frame;

FIG. 6 is a flowchart describing the process of checking if commands need to be stopped;

FIG. 7 is a flowchart describing the process of checking statuses of the input and starting commands;

FIG. 8 is a flowchart describing the process of checking if the input pattern is of a forward command;

FIG. 9 is a flowchart describing the process of checking if the input pattern is of a turning left command;

FIG. 10 is a flowchart describing the process of checking if the input pattern is of a turning right command;

FIG. 11 is a flowchart describing the process of checking if the input pattern is of a moving backwards command;

FIG. 12 is a flowchart describing the process of checking if the input pattern is of a moving upwards command;

FIG. 13 is a flowchart describing the process of checking if the input pattern is of a moving downwards command;

FIG. 14 is a flowchart describing the process of checking if the input pattern is of a moving/strafing right command;

FIG. 15 is a flowchart describing the process of checking if the input pattern is of a moving/strafing left command;

FIG. 16 is a flowchart describing the process of checking if the input pattern is of a crouching command;

### DETAILED DESCRIPTION OF THE PREFERRED EMBODIMENTS

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

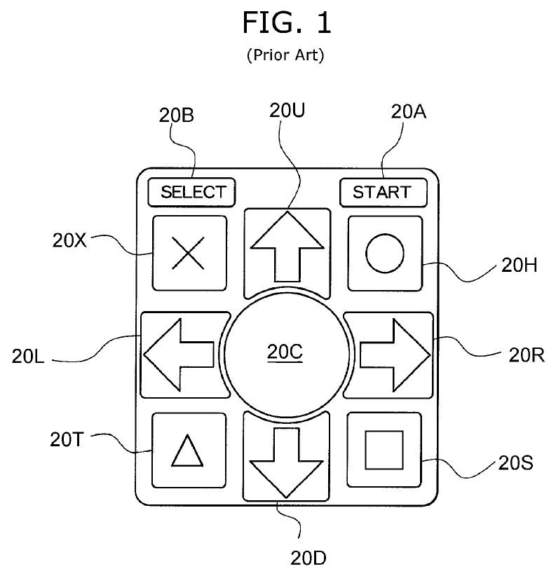

Referring to FIG. 1 there is shown a game pad similar to what is commonly known as a dance pad. If 20C were not to have a button associated with it, it would be the same as the most common dance pad available from various manufacturers. 20C is included only to point out that if a functioning button were to exist at that location it could also be included as a button for controlling the action of the game. 20X, 20U, 20H, 20L, 20R, 20T, 20D, 20S, 20B, and 20A are all foot-operated buttons.

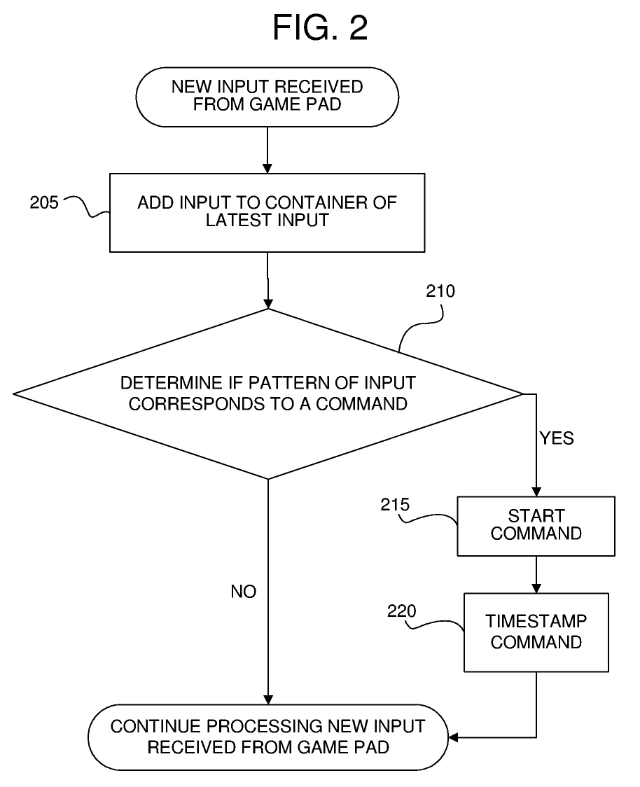

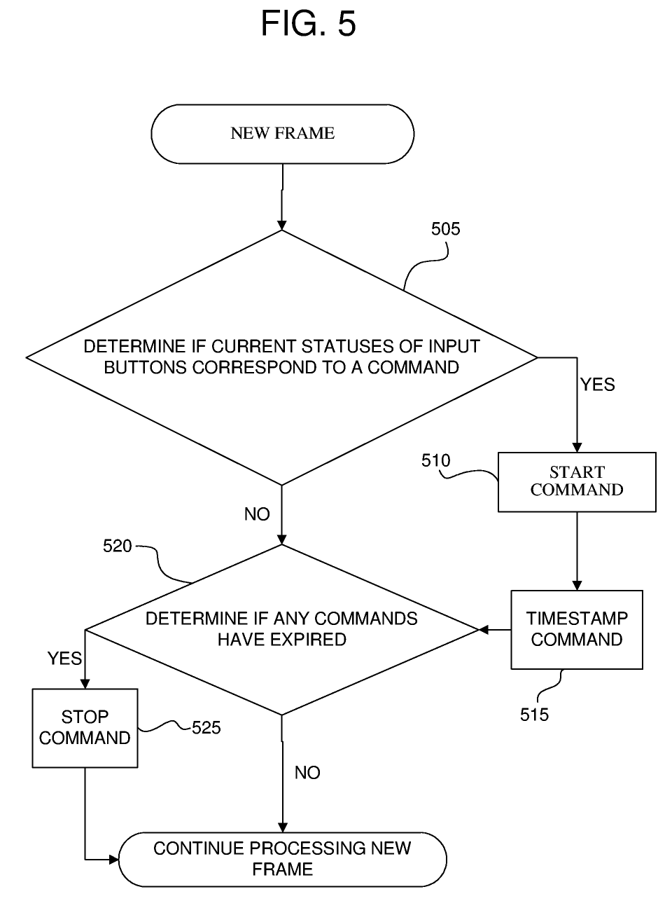

Video games typically follow the pattern that input is received from a controller and then at a predetermined interval of time the new input is processed and the display is changed to reflect the player's input and movement of time. This predetermined interval of time is commonly called the frame rate. FIG. 2 describes for this invention how new input is processed. FIG. 5 describes for this invention how a new frame is processed.

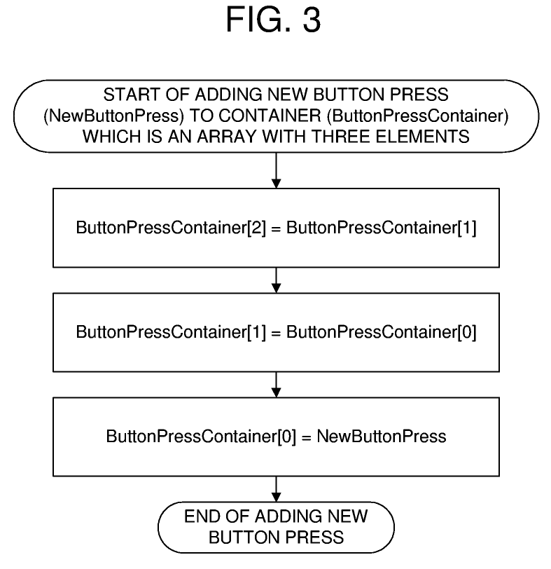

Referring to FIG. 2, as the player presses buttons on the game pad using their feet in a realistic act of movement, the input is first added to the container of latest input. Process 205 is described in FIG. 3.

Referring to FIG. 3 there is shown how the new input is placed at the beginning of the container, while older input is overwritten or removed from the container thus keeping the latest input at the beginning of the container in the order in which it occurred.

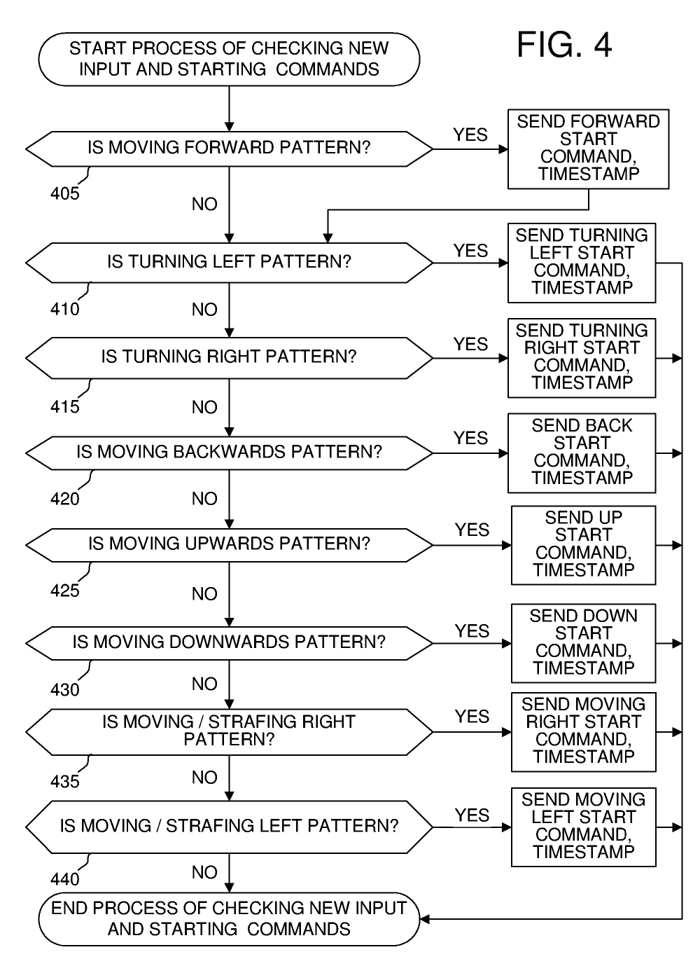

Referring to FIG. 2 there is shown that processes 210, 215, and 220 are the joint processes of checking the container for new input, starting the appropriate command, and time stamping the command. Processes 210, 215, and 220 are further described in FIG. 4.

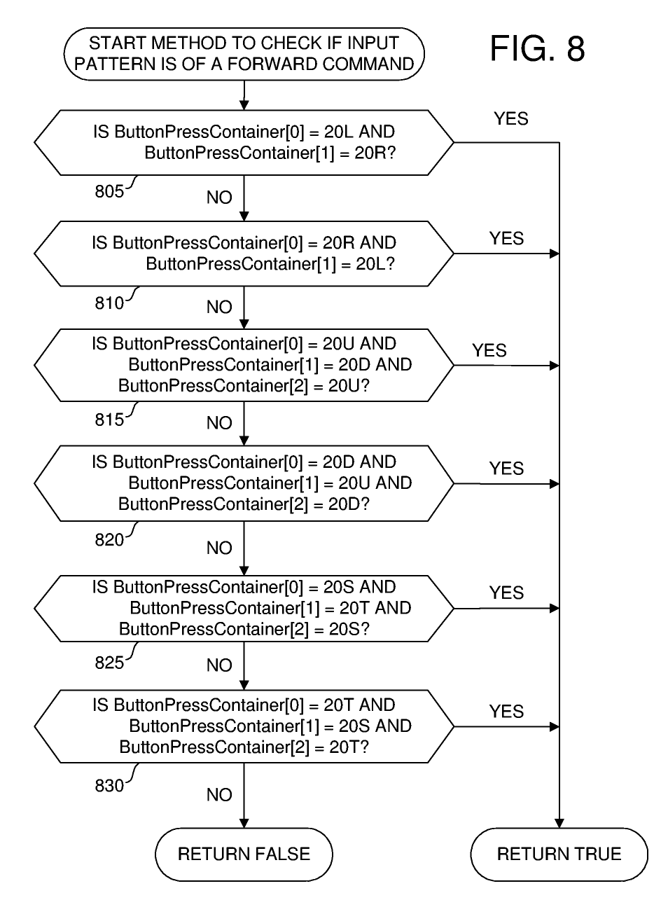

Referring to FIG. 4, decision 405 is described in FIG. 8. In FIG. 8 it is shown how the input container is analyzed to determine if the player has performed the sequence of actions to move the character forward. Just as in real life when a person walks, one foot is pressed down and then the other foot is pressed down in order to propel the individual forward. So too in this decision-making process the button 20R must be pressed down and then the button 20L must be pressed down to propel the player's character forward as shown in decision 805. Or the button 20L must be pressed down and then the button 20R must be pressed down as shown in decision 810.

Referring to FIG. 8 decision 815 and decision 820 would handle the player's actions for moving their character forward while crouching. Realistic crouching involves putting one foot directly in front of the other, so crouching and moving forward would involve sequentially stepping on buttons 20U and 20D.

Referring to FIG. 8 decision 825 and decision 830 would handle the player's actions for moving their character forward while jumping. If button 20C existed on most dance pads it would be a natural choice for jumping, but since it does not exist on most dance pads the alternative would be to use buttons 20S and 20T to represent jumping. So buttons 20S and 20T are the input which, when stepped on repeatedly by the player, moves its character forward while also issuing a move upwards/jump command.

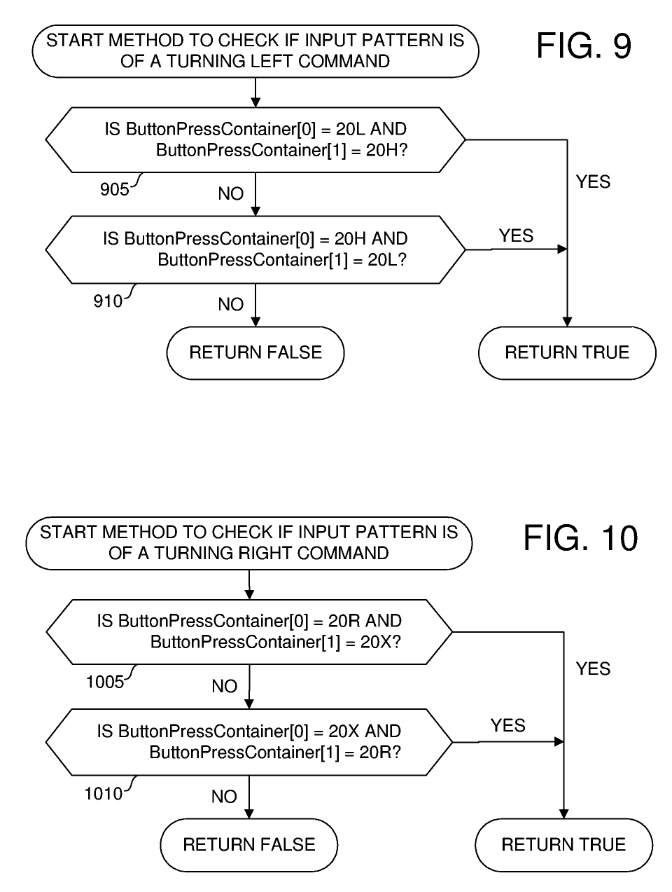

Referring back to FIG. 4, decision 410 is described in FIG. 9. In FIG. 9 it is shown how the input container is analyzed to determine if the player has performed the sequence of actions to turn the character left. Just as in real life when a person turns left, the right foot is pressed slightly ahead of the left foot. So too in this decision-making process the button 20H must be pressed down and then the button 20L must be pressed down to turn the player's character left as shown in decision 905. Or the button 20L must be pressed down and then the button 20H must be pressed down as shown in decision 910.

Referring back to FIG. 4, decision 415 is described in FIG. 10. In FIG. 10 it is shown how the input container is analyzed to determine if the player has performed the sequence of actions to turn the character right. Just as in real life when a person turns right, the left foot is pressed slightly ahead of the right foot. So too in this decision-making process the button 20X must be pressed down and then the button 20R must be pressed down to turn the player's character right as shown in decision 1005. Or the button 20R must be pressed down and then the button 20X must be pressed down as shown in decision 1010.

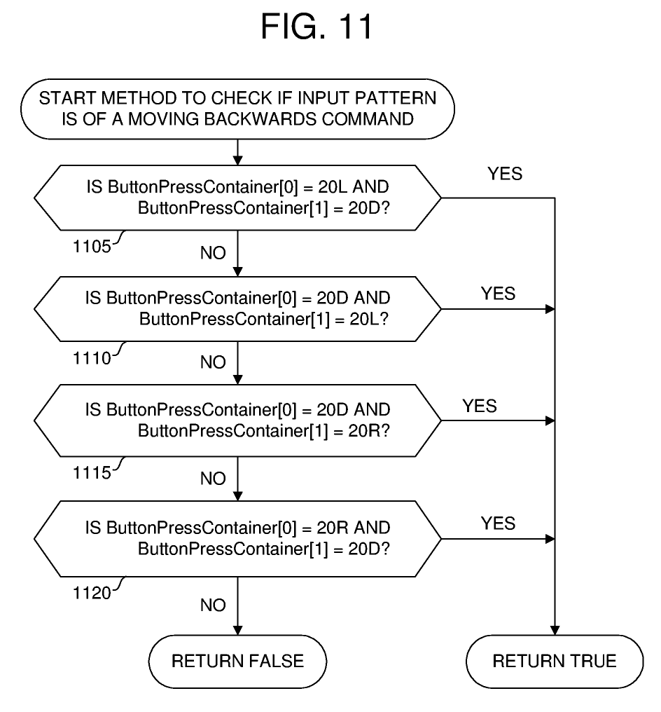

Referring back to FIG. 4, decision 420 is described in FIG. 11. In FIG. 11 it is shown how the input container is analyzed to determine if the player has performed the sequence of actions to move the character backwards. Just as in real life when a person moves backwards, one foot is pressed behind and slightly to the side of the other foot. So too in this decision-making process the button 20D must be pressed down and then the button 20L must be pressed down to move the player's character backwards as shown in decision 1105. Or the button 20L must be pressed down and then the button 20D must be pressed down as shown in decision 1110. Or the button 20R must be pressed down and then the button 20D must be pressed down as shown in decision 1115. Or the button 20D must be pressed down and then the button 20R must be pressed down as shown in decision 1120.

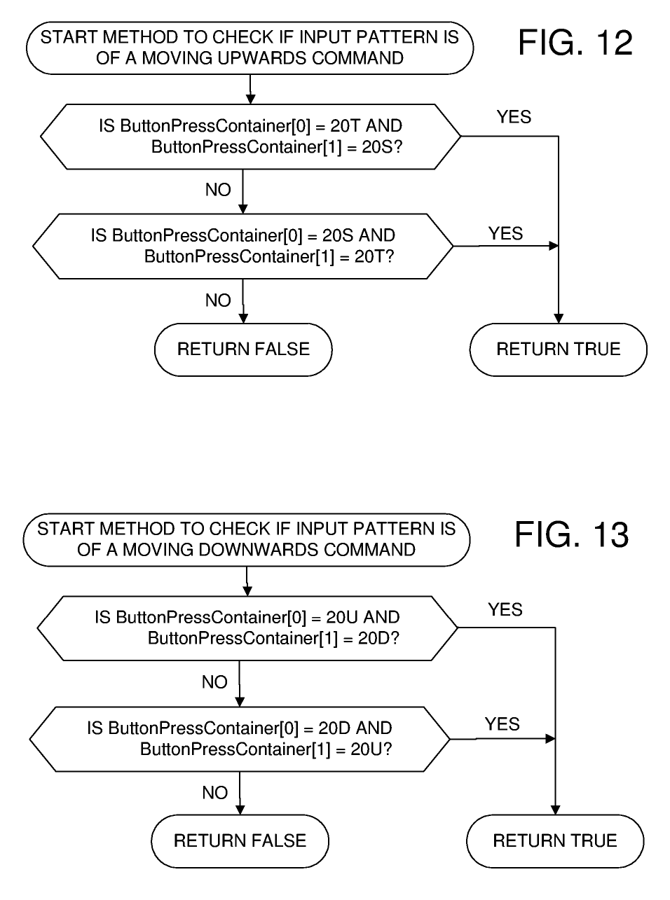

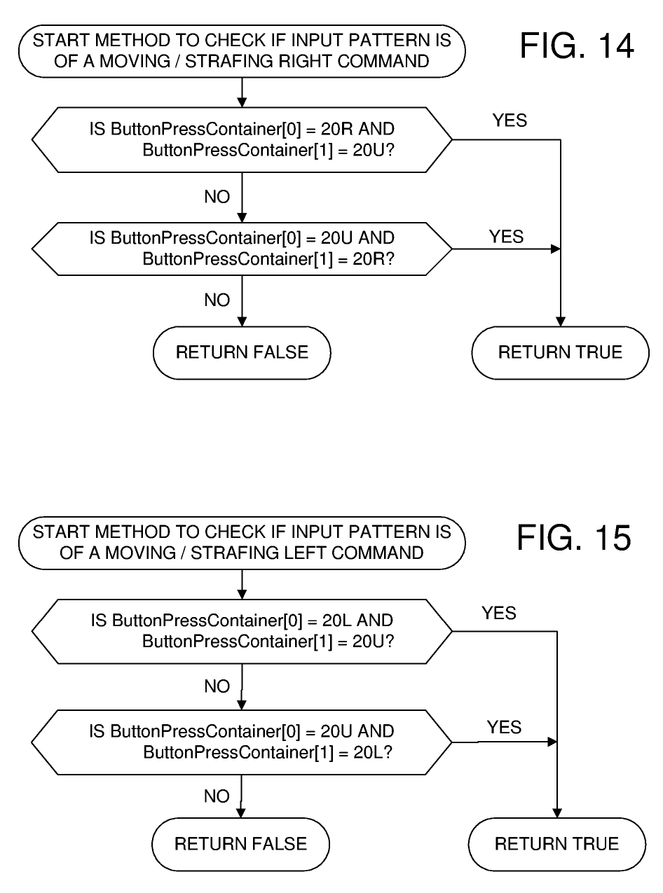

Referring back to FIG. 4, an analogous decision-making process applies to decision 425, the act of moving upwards/jumping, which is described in FIG. 12; also applies to decision 430, the act of moving downwards/crouching, which is described in FIG. 13; also applies to decision 435, the act of sidestepping right, which is described in FIG. 14; and also applies to decision 440, the act of sidestepping left, which is described in FIG. 15.

Referring to FIG. 12 there is shown that moving the player's character upwards involves the player sequentially stepping on the buttons 20T and 20S.

Referring to FIG. 13 there is shown that moving the player's character downwards involves the player sequentially stepping on the buttons 20D and 20U.

Referring to FIG. 14 there is shown that moving the player's character right, also called strafing or sidestepping right, involves the player sequentially stepping on the buttons 20R and 20U.

Referring to FIG. 15 there is shown that moving the player's character left, also called strafing or sidestepping left, involves the player sequentially stepping on the buttons 20L and 20U.

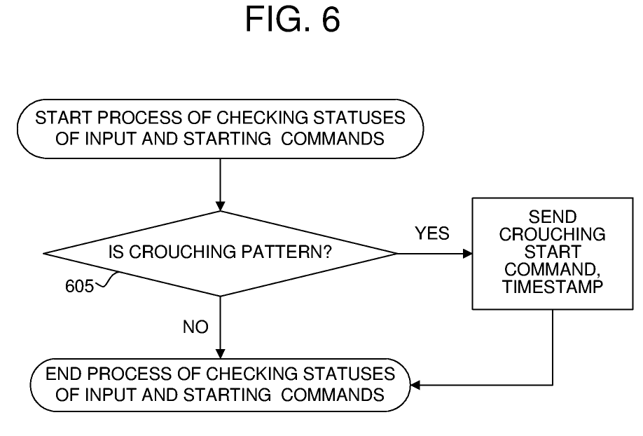

Referring to FIG. 5, processes 505, 510, and 515 are the joint processes of checking the statuses of input buttons, starting the appropriate command, and time stamping the command. Processes 505, 510, and 515 are described in FIG. 6.

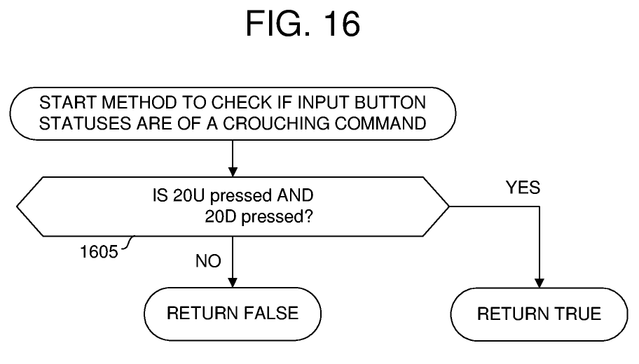

Referring to FIG. 6, decision 605 is described in FIG. 16. In FIG. 16 it is shown how the input button statuses are analyzed to determine if the player is performing the actions to put their character in the crouching position. Just as in real life when a person crouches, one foot is placed directly in front of the other. So too in this decision-making process the buttons 20U and 20D must have the player's feet pressing both of them down as shown in decision 1605.

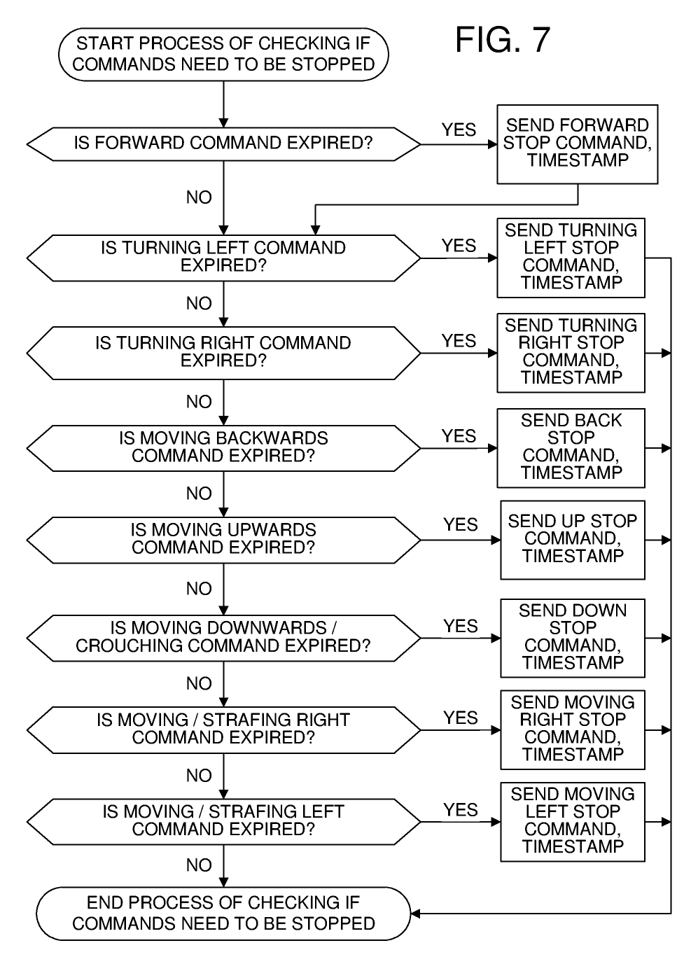

Referring back to FIG. 5, processes 520 and 525 are the joint processes of checking if any of the commands have expired. Processes 520 and 525 are described in FIG. 7.

Referring to FIG. 7 there is shown that for each possible command started there needs to be a way to stop the command. A command needs to be started and stopped to reflect the reality of the distance of the character's steps. If you wanted to mimic a character with a long forward stride you would increase the time that the forward command had before it expired. Adjusting the time to expiration of the commands is one way to more greatly reflect reality. For example, a turn to the left or right may require a quicker expiration than moving forward because a player would want more fine grained control over turning as opposed to moving forward.

A short list of alternative embodiments:
Using different combinations of buttons on a game pad to represent different commands. Such as using a combination of buttons 20X and 20H to represent the jumping command.
Game pads with different buttons. Different buttons in different shapes could be laid out in different patterns on the pad.
Changing the time to expiration of commands.
Have commands dependent on not just a pattern of inputs but what the previous command was or current in effect command is.
Have command analysis dependent on character situation. Such as using the button combination of 20T and 20S to represent swimming when the character is in water.
Different character movements. For example the combination of button presses 20L following by 20R followed by 20S could have the character do a backflip.
Combine a game pad with hand held controllers.
For games on PCs, consoles such as Microsoft's Xbox or Sony's PlayStation, and stand alone coin-operated video gaming machines.

### CONCLUSION

It can now be seen that the present invention provides a method for a player to perform realistic lower body movements on a game pad in order to control a character in a video game. These realistic body movements are due to the invention's process of storing a sequence of inputs, analyzing them, calling the appropriate command, and then stopping the command at the appropriate time.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for a player to control a character in a video game that comprises:
(a) providing a game pad with a plurality of foot-activated buttons;
(b) providing a container of the latest input from said input buttons on said game pad;
(c) analyzing patterns of said input within said container;
(d) starting commands for controlling said character based on said analysis of said patterns;
(e) providing a frame triggered periodically;
(f) analyzing current statuses of said input buttons;
(g) starting commands for controlling said character based on said analysis of said current statuses of said input buttons;
(h) analyzing of all said started commands to determine if said commands have expired;
(i) stopping said started commands based on said analysis of all said started commands;
whereby said character in said video game is controlled by realistic lower body movements by said player upon said game pad.

2. The method of claim 1 wherein said analysis of said patterns of said input from said game pad occur as new input is received.

3. The method of claim 1 wherein said analysis of said current statuses of said input buttons occur during said frame.

4. The method of claim 1 wherein said analysis of all said started commands to determine if said commands have expired occur during said frame.

5. The method of claim 1 wherein said analysis and resultant stopping of said commands occur during said frame.
